(19) United States
(12) Patent Application Publication
(10) Pub. No.: US 2025/0330797 A1
(43) Pub. Date: Oct. 23, 2025

(54) Automated Usage Informed User Cost Optimizer

(71) Applicant: Nova Labs Inc., San Francisco, CA (US)

(72) Inventors: Louis Thiery, Berkeley, CA (US); Jeff Grunewald, Columbus, OH (US); Matthew Plant, Brooklyn, NY (US); Joseph Padden, Boulder, CO (US)

(21) Appl. No.: 19/186,772

(22) Filed: Apr. 23, 2025

Related U.S. Application Data
(60) Provisional application No. 63/637,837, filed on Apr. 23, 2024.

(51) Int. Cl. H04W 8/18; H04W 4/24

(52) U.S. Cl. CPC H04W 8/18; H04W 4/24

(57) ABSTRACT

The disclosure generally shows systems and methods for optimizing MVNO subscriber mappings to pooled data pricing plans offered by MNOs with different tiered data pools are variously linked to different MVNO subscribers. The system receives and processes raw CDR data provided by the MNO. The system may then poll a backend server to receive data concerning subscriber ID assignments and subscriber activations/deactivations for the MVNO. Then the system determines optimal plan changes for each subscriber based on expected usage and pushes those plan changes to a Wholesale API Proxy that communicates with the MNO to implement the mapping changes to the pooled data pricing plan.

### CROSS-REFERENCE TO RELATED APPLICATION

This application claims priority to provisional U.S. Application Ser. No. 63/637,837, titled “Systems and Methods for Automated Usage Informed User Cost Optimizer”, and filed Apr. 23, 2024, herein incorporated by reference.

### BACKGROUND

A Mobile Virtual Network Operator (MVNO) typically does not own network infrastructure and leases the needed network infrastructure from Mobile Network Operators (MNO). Typically, the lease agreements that allow an MVNO to utilize network infrastructure owned by an MNO contain wholesale data packages. In the wholesale data packages, an MNO offers a tiered pricing plan with multiple wholesale rates that may be based on a rate per data type. The rate per data type refers to the relationship between the wholesale rate and the amount of data offered in a certain tier of the pricing plan and may be expressed as the rate of dollar per X gigabytes of data, the rate of dollar per Y minutes of talking, or the rate of dollar per Z number of SMS based text messages. The cost of these wholesale plans for an MVNO may be calculated on a periodic basis, such as a month. As an example, an MNO may offer a whole data plan with two pricing tiers. The first pricing tier might offer 100 GB for a monthly cost of $100 and the second pricing tiers might offer 200 GB of data for a monthly cost of $150. For the first tier, the rate per GB is 1 and for the second tier the rate per GB is 0.75. Thus, as explained in the example, the different tiers include a wholesale price and an amount of usable data to determine the rate per LAN (e.g., rate per GB). Further explained by the example is the typical structure of the wholesale data plans, which shows a decreasing rate per LAN as tiers include additional data. The wholesale pricing, with tiered pricing levels, are typically called “pooled data price plans.”

An MVNO contracts with each subscriber of the MNVO independently of the pooled data pricing plan contract. However, each of the subscribers of the MVNO is required to be mapped to one of the tiered pricing levels contained in the pooled data price plans. Thus, at any given time, each subscriber of an MVNO must be mapped to a tier of the pricing level and an MNO charges the MVNO based on the mapping of subscribers to each tier of the pricing level. Aspects of charging an MVNO may occur on a pro-rata basis from one of several possible time scales (e.g., daily, weekly).

There are several practical issues that arise from the setup between MVNO and subscribers and the setup between MVNO and MNO. Where an MVNO is charged monthly by the MNO, it is charged in advance of the data being consumed. As an example, where an MVNO maps subscribers to a pricing tier of a pooled data price plan that offers 100 GB of data, the MVNO pays the same amount to the MNO regardless of whether the subscribers of that pricing tier actually consume 100 GB of data. Thus, where many subscribers do not consume as much data as expected, there is unused, but paid for, data within the subscribers pricing tier level. Additionally, the MVNO creates an initial mapping of the subscribers to certain pricing tiers of the pooled data pricing plan, but an individual subscriber's data consumption habits may change over time. Thus, where an individual subscriber's data consumption habits increase or decrease over time, the initial pricing tier may not continue be the proper fit for the subscriber and the MVNO is ultimately paying more than it should to the MNO because the subscriber remains mapped to the initial pricing tier.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. To address the need for a system and method for optimizing the mapping of subscribers to an optimal tier within a pooled data pricing plan, aspects discussed herein describe systems and methods to manage the subscriber to pooled price plan mapping in order to minimize monthly cost paid by an MVNO to an MNO.

Aspects described herein provide an automated tool that optimizes the mapping of customers to different wholesale data package tiers that minimizes the monthly spend by an MVNO to an MNO Wholesale partner. The aspects described herein may apply the output from a minimization algorithm to customer accounts using a wholesale API Proxy. The aspects described herein may also produce monthly reports on key performance indicators that allow for monitoring and iterative development of the system.

Aspects described herein may utilize an algorithm which takes Pooled Data Pricing Plan details as constraints and produces an output mapping for each subscriber to a pricing plan that minimizes the monthly payment by an MVNO to an MNO. Further, aspects discussed herein may calculate the error of the algorithm output retrospectively for a previous periodic interval (e.g., a month).

Aspects discussed herein may enable automated result implementation, where backend servers of an MVNO may be used to implement the subscriber to plan mapping output via a wholesale API Proxy server. Further, aspects discussed herein may produce an audit log, showing log of changes, that is stored in a database and available for review. The audit log may contain data showing subscriber ID (e.g., IMSI/ICCID/MSISDN), date/timestamp, old plan, and new plan.

For security purposes, aspects discussed herein may operate on a set of call data records (CDRs) with encrypted and anonymous customer data (e.g., hashed or encrypted IMSI or hashed or encrypted MSISDN). Alternatively, where aspects described herein are operating in a fully secure environment, raw CDR data may be used to optimize the subscriber mapping. Where the CDRs contain encrypted and anonymous customer data, an API proxy server may determine the actual subscriber identification and produce a mapping containing the subscriber ID data so the mapping may be properly implemented by the MNO. The mapping output, when containing unencrypted and non-anonymous customer data, may be communicated securely to backend servers of the MVNO for storage purposes and logging any changes of the mapping. From the data communicated to the backend servers of the MVNO, an audit log should be generated and updated. When necessary, the audit log should have a version with encrypted customer data and a separate version with unencrypted customer data.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 illustrates an example system of some illustrative aspects discussed herein.

FIG. 2 illustrates an example process of the Pooled Data Pricing Plan evaluation loop that is implemented for every subscriber in an MVNO network, according to one or more illustrative aspects described herein.

FIG. 3 illustrates an example system of the internal composition of the optimizer and several connections to external components, according to one or more illustrative aspects described herein.

FIG. 4 illustrates a chart showing MVNO Usage Per Subscriber, according to one or more illustrative aspects described herein.

FIG. 5 illustrates an aspect where the optimizer is operated in an unsecured space, according to one or more illustrative aspects described herein.

### DETAILED DESCRIPTION

In the following description of the various aspects, reference is made to the accompanying drawings, which form a part hereof, and in which is shown by way of illustration various aspects described herein may be practiced. It is to be understood that other aspects discussed herein may be utilized and structural and functional modifications may be made without departing from the scope of the described aspects. Aspects described herein are capable of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

Mobile Network Operators (MNO)—Mobile Network Operators own, operate, and maintain cellular network infrastructure and may lease such infrastructure to other entities.

Mobile Virtual Network Operators (MVNO)—MVNO's offer a mobile phone service without owning their own network infrastructure. As such, the MVNO leases network infrastructure from MNOs.

International Mobile Subscriber Identity (IMSI)—The IMSI is a unique identifier assigned to a SIM card by an MNO.

Mobile Station International Subscriber Directory Number (MSISDN)—The MSISDN is the international format of a mobile phone number and may be an essential identifier for routing calls and messages through telecommunication networks. The MSISDN contains the following elements: (i) Country Code, identifying the country of the subscriber, (ii) National Destination Code, represents the subscriber's mobile network or operator, and (iii) the subscriber number, a unique number assigned to the user within the operator's network. The MSISDN facilitates several critical telecom functions such as (i) public subscriber identification that is used by others (e.g., typical phone number), (ii) routing of calls, messages and data traffic, and (iii) generate billing records for services utilized by the subscriber.

Integrated Circuit Card Identification (ICCID)—The ICCID is an 18-22 digit code that identifies a SIM card.

Pooled Data Pricing Plans, offered by an MNO to an MVNO, contain 5 main components (i) Monthly Recurring Cost (MRC), (ii) Pooled Data Service Usage Allowance, (iii) Data Service Overage Rate, (iv) Daily Average Subscriber Count, and (v) Call Data Records (CDRs). Components (i)-(iii) may serve as the basis for the pricing of different tiers in the Pooled Data Pricing Plan.

The first component, the MRC, is the cost an MVNO pays to an MNO each month based on the fourth component, Daily Average Subscriber Count. The Daily Average Subscriber Count may be determined by the MNO that finds the average number of Active End User SIMs within an MNO system that were assigned to each tiered pricing level for a given billing cycle. For each tiered pricing level, the MNO adds up the number of Active End User SIMS for each day of the month and divide that by the number by the total number of days in the billing cycle.

The second component, the Pooled Data Service Usage Allowance represents the data usage allowance for each tiered pricing level of the Pooled Data Pricing Plan. Typically, the amount of data usage allowance is added to the subscribers of the respective tier daily for each subscriber. The MNO's may determine the Pooled Data Service Usage Allowance for each tier is the amount of data added to the pool when multiplied by the Daily Average Subscriber Count. The data added to the pool may be added on a pro-rata basis, daily, for each subscriber based on the count of days in the month.

The third component, the Data Service Overage Rate, is the billing rate for data that exceeds the applicable Pooled Data Service Usage Allowance. Aspects of the Data Service Overage Rate may be charged based on the pooled allowance and pooled data usage for a given tier of the pricing plan. As an example, two individual users in the same plan tier may each add 1 GB of data allowance to the allowance pool, thereby having a 2 GB pooled data allowance total at the end of the month. Where the first user consumes 0.5 GB of data and the second user consumes 1.5 GB of data, there will be no overage charge for that given month. Where the first user consumes 1 GB of data and the second user consumes 1.5 GB of data, the 0.5 GB over the 2 GB total allowance is charged the overage rate. Aspects of the described overage charge example may be extrapolated to any number of users in a given tier pool. Typically, as the amount of data and MRC increase, the Data Service Overage Rate decreases.

The fifth component, the CDRs, are periodically provided by an MNO to an MVNO. The CDRs indicate data usage of MVNO subscribers over a period of time and may contain any associated meta-data of such data usage. Aspects of the CDRs may provide event type (e.g., data, voice, SMS), event start timestamp, user IDs (e.g., ICCID, IMSI, IMEI, MSISDN), tower ID (e.g., form of location data), radio type (3G, 4G, LTE, 5G, Wi-Fi), on net/off-net (e.g., roaming, uplink bytes, downlink bytes, total bytes), voice call minutes, or the like.

An example Pooled Pricing Data Plan is shown in Table 1 below. Several aspects discussed herein are relevant to understand with the Pooled Pricing Data Plan: (i) the per-GB price is reduced as the size of the plan increases and (ii) the data overage costs are reduced as the size of the plan increases.

TABLE 1

| Price Plan | Pooled Data | Pooled Data | Pooled Data | Pooled Data | Pooled Data |
|---|---|---|---|---|---|
| Components | Price Plan 1 | Price Plan 2 | Price Plan 3 | Price Plan 4 | Price Plan 5 |
| MRC | $10.00 | $18.00 | $26.00 | $34.00 | $42.00 |
| Pooled Data | 2,048 MB | 4,096 MB | 8,192 MB | 16,384 MB | 32,768 MB |
| Service | | | | | |
| Usage | | | | | |
| Allowance | | | | | |
| Data Service | $0.085 per | $0.070 per | $0.055 per | $0.040 per | $0.025 per |
| Overage Rate | MB | MB | MB | MB | MB |

Typically, an MNO bills the Pooled Data Pricing Plans on a pro-rata basis (e.g., daily, weekly) based on the MRC for a given tier. As an example, assuming billing for the month is determined on a daily basis, if a subscriber is a member of plan 1 for the first half of the month, using 0.5 GB of data, and plan 2 for the second half of the month, using 0.5 GB of data, that subscriber contributes 0.5 GB usage allowance to each plan respectively. Further, usage which occurred while the subscriber was either of member of plan 1 or plan 2 has the respective usage aggregated against the respective plan.

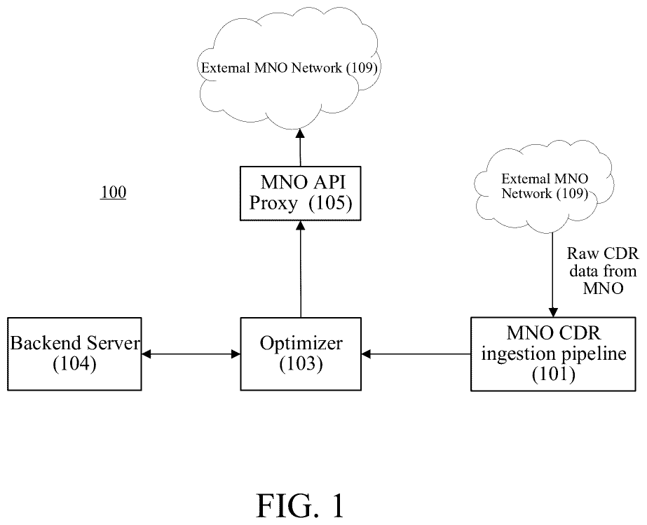

FIG. 1 illustrates an aspect of the system 100. The CDR ingestion pipeline 101 may stream raw CDR data to the optimizer 103. The CDR ingestion pipeline may comprise any now known or future process for an MVNO receiving the appropriate raw CDR data. The MNO may provide the raw CDR data to the CDR ingestion pipeline 101 on a periodic basis (e.g., daily, weekly, bi-weekly, monthly, or the like). The CDR data may be provided through the CDR ingestion pipeline 101 as .csv files. The .csv files may be delivered through the CDR ingestion pipeline 101 via secure file transfer protocol (SFTP), but also may be delivered using any suitable alternative method known in the art. The.csv files may be delivered on a periodic basis (e.g., every 15 mins) and may be arrive at optimizer 103 without the internal CDR data being properly time-ordered. As such, optimizer 103 may re-organize the CDR data as it is received so optimizer 103 may reassemble a monotonic timeline for processing. CDR data may be ingested by an AWS Lambda function into an AWS S3 storage bucket which can be drawn from by various components in the system 100, such as optimizer 103. When CDR data is sent from an MNO, it may include information indicating the data usage from every subscriber in the MVNO's network with all associated meta-data. The associated meta-data of the CDR data may comprise IMSI/MSISDN identifiers, date/timestamp, services used, location, or any other meta-data typically collected and associated with CDR data. The optimizer 103 may receive and process the CDR data. Aspects of processing the CDR data may comprise encrypting or hashing the subscriber identification information so such information is anonymous to the system. Additionally, processing the raw CDR data may comprise generating tabular versions of the aggregate raw CDR data for more efficient use of such data by the components of the system.

The optimizer 103 may poll a backend server 104 to determine subscriber activation/de-activation data. For subscriber activation data, at times, a subscriber may have activated a device but has not yet used the device in such a way that generates CDR data. In such scenarios, it is preferable for the optimizer to understand the whole subscriber base, not just those subscribers that have generated CDR data. The backend server 104 may additionally process and/or store all historical data relating to subscriber identification data of subscribers of the MVNO. Subscriber identification data may be used to capture multiple SIM activations for multiple devices that are tied to the same subscriber. Typically, where a user activates a new cellular port, the user receives a SIM card and identifier associated with the SIM card. More recently, however, SIM cards have become embedded in the hardware of the cellular device and as such, the e-SIM cannot be moved from one phone to the next. So, should a subscriber get a new phone, the subscriber gets a new SIM card and identifier. To ensure the aspects of the optimizer 103 consider usage by all devices tied to a single subscriber, those devices may all be associated with a unique subscriber ID. After receiving the subscriber activation/de-activation data and subscriber ID assignments from the MVNO backend systems, the optimizer 103 determines the optimal changes of subscribers to one of the tiers of the Pooled Data Pricing Plan. The optimal changes are pushed to the backend server 104 and the Wholesale API Proxy server 105.

Aspects of optimizer 103 may provide for pre-populating certain data containers concerning subscriber account creation in a pre-activated state. Aspects of providing subscriber account creation in a pre-activated state may include optimizer 103 polling the backend server 104 for new and canceled subscribers and pre-activating data containers for the new subscribers. Then optimizer 103 may perform all optimizations reactively in response to CDR consumption regarding those pre-activated subscriber data containers, which may minimize errors from incomplete or erroneous subscriber activations, which may occur in consumer wireless subscriptions. Aspects of the optimizer 103 may process CDR data in real time as such data is received from the CDR ingestion pipeline 101.

Aspects of the Wholesale API proxy server 105 described herein provide decrypting the previously encrypted identification information because of regulatory restrictions on who may access customers personally identifiable information. Thus, when the optimizer 103 pushes plan changes to the Wholesale API proxy server 105, it is responsible for decrypting subscriber information and sending the output mapping with decrypted subscriber information to an MNO for implementation.

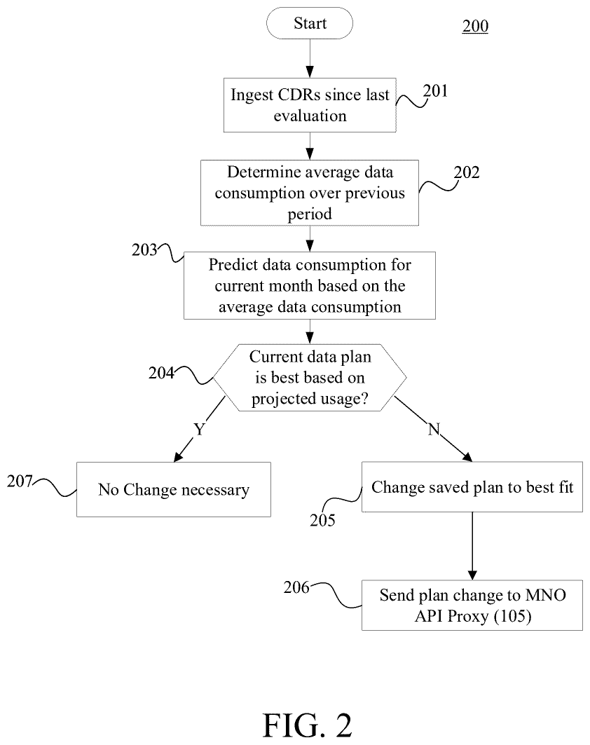

FIG. 2 describes a process where the optimizer 103 may determine optimal changes to the Pooled Data Pricing Plan for each subscriber of an MVNO. At Step 201, the optimizer 103 may process the raw CDR data since the optimizer last determined optimal changes. As previously discussed, processing the raw CDR data may comprise encrypting subscriber identification data or hashing subscriber identification data and generating tabular results of the CDR date. The optimizer 103 may undertake the process of FIG. 2 on a periodic basis (e.g., hourly, daily, weekly). The optimizer 103 may also undertake the process of FIG. 2 based on the occurrence of certain events (e.g., new CDR data arriving from the CDR ingestion pipeline 101) which will kick off the start of the process at step 201. At step 202, the optimizer 103 may determine the average data consumption over a previous period. The previous consumption period may be any reasonable interval of time (e.g., 1 week, 1 month, every 4 months). Additionally, the previous period may equate to the billing period set by an MNO. The optimizer 103 determines each subscriber's average data consumption by aggregating the subscriber's daily data consumption and dividing that by the number of days in the previous period.

At step 203, the optimizer 103 predicts data consumption for the upcoming time period. Typically, the upcoming time period represents the next time period that an MVNO is billed for subscriber usage. Additionally, the upcoming time period may equate to the time period of the billing cycle set by the MNO. At step 204, the optimizer 103 evaluates the current subscriber mapping to the pooled data pricing plans based on the predicted data consumption for the current period. The optimizer evaluates if, based on the predicted data consumption, each user is placed in the correct tier of the pooled data pricing plan or if the subscriber should be moved to a separate tier of the pooled pricing data plan. If the answer to step 204 is NO, meaning the user is not in the correct tier based on their predicted data usage, the optimizer 103 then determines the necessary plan changes to the current data plan and at step 206 the optimizer 103 pushes those changes to the Wholesale API proxy 105. IF the answer to step 204 is YES, meaning the subscriber is in the correct tier based on predicted data usage, then the optimizer does not need to determine any changes to the current subscriber mapping and does not push any plan changes to the backend system 104 or the Wholesale API Proxy server 105.

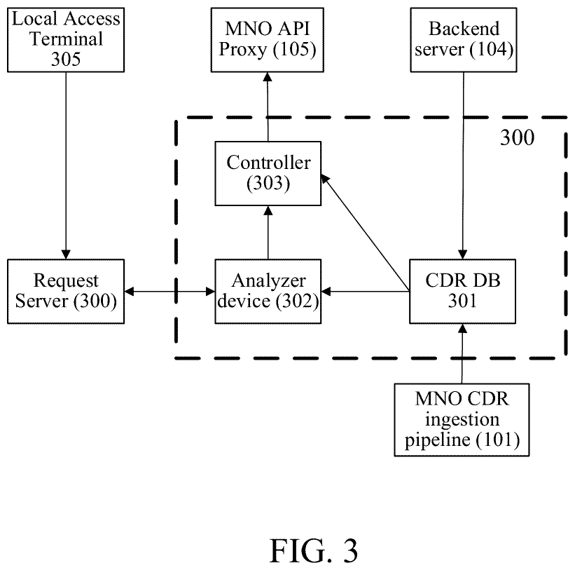

FIG. 3 shows internal components of the optimizer 103 and any external connections of those components. CDR database 301 may receive the streams of CDR's from the CDR ingestion pipeline 101. CDR database 301, internal to optimizer 103, may process and normalize the CDR data by encrypting any customer identifying data contained within the CDR data. Thus, the optimizer 103 does not know the real identity of the SIM card or the real identity of the MSISDN when determining optimal plan changes.

The processed CDR data may be broadcast to analyzer 302 and/or controller 303. Either the analyzer 302 or the controller 303 may poll the CDR database 301 as needed and the CDR database 301 may respond to the polling by sending any processed and normalized CDR data.

Aspects of the analyzer 302 described herein may produce a data usage analysis on a periodic basis (e.g., daily, weekly, monthly, or the like). Results of the data usage analysis may show (i) how much data is consumed in each tier of the pooled pricing data plan, or (ii) how much data, based on the allotted amount of available per tier, remains available in each tier of the pooled pricing data plan. Additional aspects of analyzer 302 described herein may determine an optimal subscriber mapping that balances all subscribers of the MVNO amongst the different tiers of a pooled pricing data plan. Aspects of the analyzer 302 may provide for temporal activity profiling, wherein analyzer 302 may assess a subscriber's typical usage over a previous X type of days that matches the next day's profile (e.g., weekday, weekend, day-of-week).

Aspects of analyzer 302 may provide for determining to escalate a subscriber to a different plan tier with the lowest overage rate cost when no pre-paid capacity is available for that given subscriber in a plan tier. As an example, a given subscriber may belong to a plan tier offering 10 GB of data with ten total subscribers in the plan tier. If nine of the ten subscribers together consume 10 GB of data, and the given subscriber consumes 0.5 GB of data, then the 0.5 GB is charged the overage rate. In such an example, analyzer 302 may determine which plan tier has the lowest overage rate and elevate/de-elevate the given subscriber to such a plan tier to minimize the overage charge.

Additional aspects of the analyzer 302 described herein may use a 2-pass optimization algorithm to optimize the mapping of subscribers to the Pooled Pricing Data Plan tiers. Pass 1 may run once per day, typically overnight when usage is low and determines a fit for each user into an optimal pricing plan bucket. Determining the fit may be based at least on the following heuristics (i) after midnight, assign each user to what would have been the “ideal pool” yesterday, and (ii) if a user is then within the overage data following that assignment, the user is escalated to the next pricing pool in the plan. The aspects described herein of Pass 1 may also determine a user should be de-escalated to a lower pricing tier in the pooled data pricing plan.

Pass 2 detects unused data in a given pricing tier and “use up” that data by taking the lowest volume users from the pool data pricing plan above the current one and move the lowest volume users to the current tier. If a tier has excess data that its constituent users have not consumed, that data is already paid for by the associated MRC cost and so Pass 2 aims to ensure the paid data is used up, otherwise it is simply lost data which has been paid for.

Aspects of the request server 300 described herein may receive a query from a local access terminal 305 requesting analysis results received from the analyzer 302 and stored at request server 300. After receiving the query, request server 300 may locate the requested analysis results and send such analysis results for viewing at the local access terminal.

Aspects of controller 303 described herein may communicate with external connections (e.g., the Wholesale API Proxy server 105, the backend server 104, or local access terminal 305). As part of that communication, the controller 303 may implement the balancing analysis of the subscriber mapping received from the analyzer 302. The controller 303 orchestrates the external interactions concurrently while the database 301 receives and process raw CDR data and concurrently while the analyzer processes different inputs and outputs different results of the analysis process. Each component of the optimizer 103 may operate concurrently and communicate with the other internal components when requested or when an event occurs that requires communication with the other internal components.

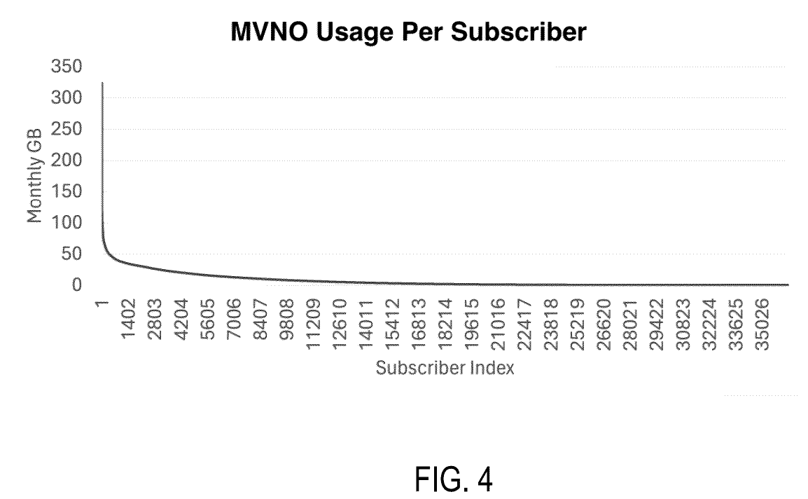

FIG. 4 illustrates a chart describing how, in the aggregate, as more subscribers join the subscriber base of an MVNO, the data usage per subscriber for a given month is reduced. FIG. 4 may illustrate how the optimizer 103, based on the long tail nature of user distribution, provides economic benefit for an MVNO.

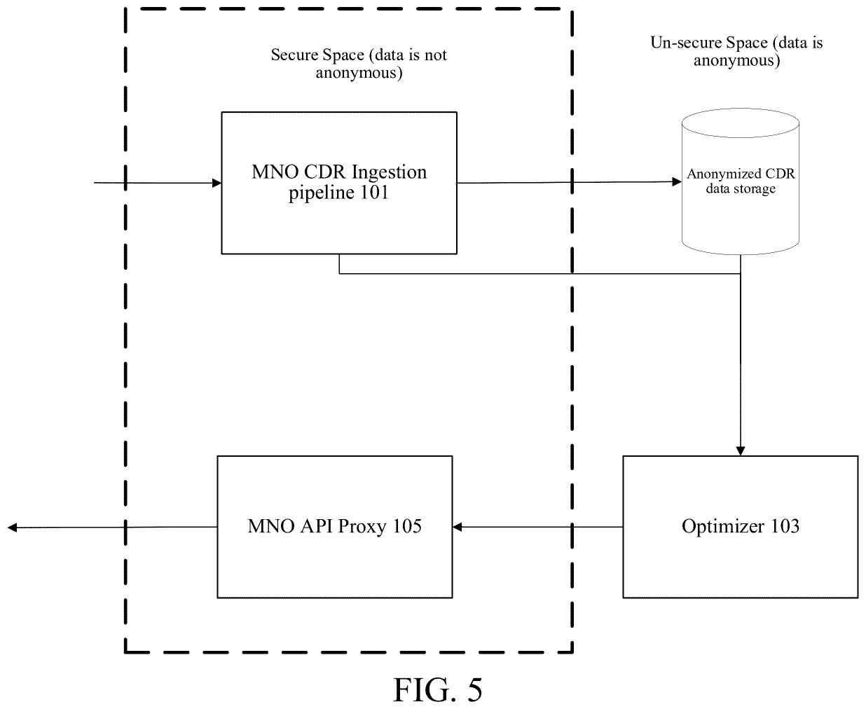

FIG. 5 illustrates an aspect of the system where the optimizer 103 is located in a remote, un-secured space relative to the MVNO. Aspects of FIG. 1 previously described herein generally apply to the aspects described in FIG. 5, except the CDR ingestion pipeline comprises processing of the raw CDR data to encrypt subscriber identification data before being received at the optimizer 103. Further, the database 301, in the aspects described in FIG. 5, receives the CDR data with encrypted subscriber identification data and may only generate tabular results of the CDR data prior to broadcasting such data to the analyzer 302 and the controller 303. Additional aspects of FIG. 5 may provide a closed-loop feedback for the CDR ingestion pipeline based on the CDR data with encrypted subscriber identification data. After optimizer 103 determines optimal plan changes, those changes are pushed to the Wholesale API Proxy server 105 which may operate similarly to previous aspects described herein by determining the actual subscriber identification to be attached to the optimal plan changes so those plan changes are properly implemented by the MNO.

Aspects of the example system described in FIG. 5 may prioritize operating within a fully secured internal compute environment controlled by an MVNO. A fully secured internal compute environment may provide isolating optimizer 103 alongside any MNO CDR ingestion pipeline 101 and MNO API Proxy 105. The MNO API proxy 105 may provide the only egress point for data and isolating the decryption of subscriber identifiers. The MNO CDR ingestion pipeline may be the only ingress point of data from outside the environment. The example system described in FIG. 5 may abstract the encrypted and volatile identifiers (e.g., IMSI/MSISDN/ICCID, which may be described as fungible in relation to the subscriber plan), so optimizer 103 may only be concerned with the anonymized internal UUID's for each subscriber, which may provide a more secure environment.

Additionally, several performance characteristics may be monitored by the system to track the performance of the optimizer 103. First, the subscriber count per pooled plan per day. Second, the average subscriber usage within the cohort sharing each pooled plan per day. Third, cumulative consumption per pooled plan following wholesale billing cycle (e.g., monthly). Fourth, estimate of monthly bill based on daily active subscriber count, pool MRC pricing, and overage pricing, which is updated daily. Fifth, the estimate of the previous month. Aspects of monitoring performance characteristics may provide for verifying an invoice received by an MNO, evaluating the performance of the optimizer to determine amounts of remaining data and/or additional amount money that could have been saved by an MVNO if the remaining amounts of data are not consumed or if customers were placed in different “buckets”, and/or to look for subscribers in the MVNO network who may be consuming large amounts of data to receive a notification regarding their data consumption.

Aspects of monitoring may provide for tracking the current available pool of data per plan tier. The current available pool of data per plan tier may be determined based on the Daily Active Subscriber count multiplied by the tier data allowance per assigned subscriber. Aspects of optimizer 103 may provide for adjusting individual users in data overage, based on the user's average consumption (e.g., per day), to tiers with additional/underused capacity based on determining the current available pool of data per plan tier.

Aspects of monitoring may provide for real-time plan tier pool allowance availability tracking. A concurrent tally may be kept based on the total available data allowance per plan tier and based on Daily Active Subscriber assignments. The concurrent tallies may be deducted in real time as CDR data is received and processed. Aspects of monitoring may further provide time-based profiling of average subscriber activity to more accurately reflect average data consumption relative to subscribers' work/life activity.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and devices used may vary, and are secondary to the functionality that they provide, as further described herein.

One or more aspects described herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language (e.g., Rust) that is subsequently compiled for execution, or may be written in a scripting language such as (but not limited to) HTML, XML, or Python. The computer executable instructions may be stored on a computer readable medium such as a hard disk, optical disk, removable storage media, solid state memory, RAM, etc. As will be appreciated by one of skill in the art, cloud storage and cloud compute may also be utilized (e.g., AWS services that reside in the AWS public cloud). As will be appreciated by one of skill in the art, the functionality of the program modules may be combined or distributed as desired in various aspects discussed herein. In addition, the functionality may be embodied in whole or in part in firmware or hardware equivalents such as integrated circuits, field programmable gate arrays (FPGA), and the like. Particular data structures may be used to more effectively implement one or more aspects, and such data structures are contemplated within the scope of computer executable instructions and computer-usable data described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as illustrative forms of implementing the claims.

What is claimed is:

1. A method, comprising:
receiving, by a computing device, first data indicating data consumption for a plurality of users subscribed to a service and a current mapping of each of the plurality of users to one of a plurality of subscription levels of the service;
determining, for each of the plurality of users and based on the data consumption of each of the plurality of users, average data consumption over a first period of time;
predicting, for each of the plurality of users and based on the average data consumption over the first period of time, data consumption over a second period of time;
determining, based on the predicted data consumption, one of the subscription levels matching each user of the plurality of users;
generating, based on determining the subscription level of each user of the plurality of users, a new mapping of the plurality of users to subscription levels of the service; and
outputting, by the computing device, the new mapping.

2. The method of claim 1, wherein the service comprises one of: a messaging service, a video message service, telephony services, a radio service.

3. The method of claim 1, further comprising:
determining, based on monitoring, one or more metrics: user count per subscriber level, average data usage by each user of the plurality of users, cumulative data consumption per subscription level, estimate of costs of the service based on daily user count, pricing of the subscription levels and costs of data overage.

4. The method of claim 1, further comprising:
generating, based on the first data, encrypted first data indicating anonymous subscriber identification data for each user of the plurality of users subscribed to the service.

5. The method of claim 1, further comprising:
generating, by the computing device, an audit log indicating one or more differences between the current mapping and the new mapping.

6. The method of claim 5, wherein the generated audit log contains encrypted subscriber identification data for each user of the plurality of users subscribed to a service.

7. The method of claim 1, further comprising:
generating, by the computing device, a first audit log indicating one or more difference between the first mapping and the second mapping; and
generating, by the computing device, a second audit log indicating one or more differences between the first mapping and the second mapping, wherein the second audit log contains encrypted subscriber identification data.

8. The method of claim 7, further comprising:
receiving, via an interface, a request by a user for one of the first or second audit logs;
causing, via the interface and viewable by the user, output of the requested first or second audit log.

9. The method of claim 1, further comprising:
determining, based on the current mapping, a cost of the service; and
determining, based on implementing the new mapping, an updated cost of the service.

10. A method for optimizing mapping of users, comprising:
receiving, by a computing device, first data indicating data consumption for a plurality of users subscribed to a service and a current mapping of each of the plurality of users to one of a plurality of subscription levels of the service;
determining, based on the respective data consumption, data consumption over a period of time for each user of the plurality of users;
determining, based on the data consumption over the period of time for each user, an expected subscription level for each user for the period of time;
determining, based on the first data and based on the expected subscription level for each user, the expected subscription level of a user is different from the subscription level of the user in the first data;
generating, based on determining the expected subscription level is different from the subscription level of the user in the first data, an updated mapping, wherein the updated mapping includes the expected subscription level of the user; and
outputting, by the computing device, the updated mapping.

11. The method of claim 10, wherein the service comprises one of: a messaging service, a video message service, telephony services, a radio service.

12. The method of claim 10, further comprising:
determining, based on monitoring, one or more metrics: user count per subscriber level, average data usage by each user of the plurality of users, cumulative data consumption per subscription level, estimate of costs of the service based on daily user count, pricing of the subscription levels and costs of data overage.

13. The method of claim 12, wherein the determining one or more metrics is determined on a periodic recurring basis.

14. The method of claim 10, further comprising:
generating, based on the first data, encrypted first data indicating anonymous subscriber identification data for each user of the plurality of users subscribed to the service.

15. The method of claim 1, further comprising:
generating, by the computing device, a first audit log indicating one or more difference between the current mapping and the updated mapping; and
generating, by the computing device, a second audit log indicating one or more differences between the current mapping and the updated mapping, wherein the second audit log contains encrypted subscriber identification data.

16. The method of claim 17, further comprising:
receiving, via an interface, a request by a user for one of the first or second audit logs;
causing, via the interface and viewable by the user, output of the requested first or second audit log.

17. The method of claim 1, further comprising:
determining, based on the current mapping, a cost of the service; and
determining, based on implementing the new mapping, an updated cost of the service.

18. A method for optimizing mapping of users, comprising:
receiving, by a computing device, first data indicating a first group of users, of a plurality of users, associated with a first level of a service and second data indicating a second group of users, of the plurality of users, associated with a second level of the service, wherein the first level and second level of the service are associated with different maximum data usage levels;
determining, for the first level, total data usage of the first group of users is less than the maximum data usage level associated with the first level;
determining, based on the total data usage being less than the maximum data usage level, an amount of available data usage for the first level;
determining, based on an amount of available data usage for the first level and based on data usage of the second group of users, the data usage of a user of the second group of users to be within a predetermined amount of available data usage for the first level;
generating, based on the user of the second group of users, a first mapping of the first users associated with the first level of the service, wherein the mapping comprises the user of the second group of users;
generating, based on the user of the second group of users, a second mapping of second users associated with the second level;
generating, based on the first mapping and the second mapping, a combined mapping; and
outputting, by the computing device, the combined mapping.

19. The method of claim 18, further comprising:
generating, based on the first data, encrypted first data indicating anonymous subscriber identification data for the first users subscribed to the first level of the service; and
generating, based on the second data, encrypted second data indicating anonymous subscriber identification data for the second users subscribed to the second level of the service.

20. The method of claim 18, further comprising:
determining, based on the first data and the second data, a cost of the service; and
determining, based on the combined mapping, an updated cost of the service.
